(19) United States
(12) Patent Application Publication
(10) Pub. No.: US 2023/0278000 A1
(43) Pub. Date: Sep. 7, 2023

(54) PHOSGENE PRODUCTION UNIT

(71) Applicant: BASF SE, Ludwigshafen am Rhein (DE)

(72) Inventors: Jan Pablo JOSCH, Ludwigshafen am Rhein (DE); Stefan ENGELS, Ludwigshafen am Rhein (DE)

(21) Appl. No.: 18/017,679

(22) PCT Filed: Jul. 27, 2021
(86) PCT No.: PCT/EP2021/070974

§ 371 Date: Jan. 24, 2023

(30) Foreign Application Priority Data
Jul. 27, 2020 (EP) 20187865.9

(51) Int. Cl. B01J 19/24; C01B 32/80

(52) U.S. Cl. CPC B01J 19/24; C01B 32/80; B01J 2219/00036

(57) ABSTRACT

A unit for producing and/or processing phosgene, preferably for producing and processing phosgene, said unit being configured for at least one production mode and at least one maintenance mode and comprising a structure which defines a confined space in a production mode, wherein (i) the confined space contains at least one apparatus for producing phosgene, or for processing phosgene, or for producing and processing phosgene; (ii) the structure comprises at least one openable and lockable transfer means for temporary removal, in a maintenance mode, of at least part of at least one apparatus according to (i) from the structure through at least one of said transfer means in opened state.

The present invention relates to a unit for producing and/or processing phosgene, preferably for producing and processing phosgene, being configured for at least one maintenance mode and at least one production mode and comprising a structure which defines a confined space in a production mode, to a production plant comprising such a unit, and to the use of such a unit in a production plant.

Phosgene is an important intermediate in the chemical industry. It is for example needed for producing isocyanates. In a commonly used process it is generated from carbon monoxide and chlorine in an exothermic reaction. Since phosgene is a highly toxic substance, safety measures must be taken that prevent phosgene from reaching the environment in case of a malfunction or leakage of an apparatus or a pipe containing phosgene.

In a known safety concept, a production unit for producing and/or processing phosgene, preferably for producing and processing phosgene, comprises a structure which defines a confined space in a production mode. This confined space contains at least one apparatus for producing phosgene, or for processing phosgene, or for producing and processing phosgene. Most often, the confined space contains at least one apparatus for producing phosgene and at least one apparatus for processing phosgene, such that the production and/or the processing of the phosgene, preferably the production and processing of the phosgene, takes place in the confined space inside the same structure such that the phosgene is confined in this structure during its “whole lifetime”. Since of course it must be possible to get access to the apparatuses inside the structure, the structure usually comprises at least one openable and lockable access means for temporary access of at least one of the apparatuses from outside the structure in a maintenance mode.

In case that maintenance work at the least one apparatus for producing and/or processing phosgene needs to be performed, usually all apparatuses in the confined space are emptied from phosgene. For this purpose, the unit comprises a flushing device. After the apparatuses have been empties from phosgene, the openable and lockable access means is opened and at least one maintenance worker enters the structure. Since all apparatuses are phosgene-free, the maintenance worker usually does not wear a full protective suit. Of course, it is usually desired that the maintenance work is finished as quickly as possible.

It was therefore an object of the invention to provide a unit for producing and/or processing phosgene, preferably for producing and processing phosgene, that allows at least in some cases maintenance work in a shorter period of time.

First Type of Inventive Unit

It has been found out that maintenance work on an apparatus inside the structure is often noticeably slowed down because the maintenance worker has too less space: In order to save space, the apparatuses and other necessary installations like lines, cables, etc. are packed relatively tightly inside the structure. It has further been found out that it can be overall time-saving to demount an apparatus or a part of this apparatus, and move that apparatus or part of the apparatus at least partially out of the structure such that the maintenance work can be performed outside the structure. So, according to a first inventive concept, the structure is designed such that it allows a transfer of an apparatus for producing phosgene or for processing phosgene or for producing and processing phosgene or at least a part of such an apparatus out of the structure.

Therefore, the present invention relates to a unit for producing and/or processing phosgene, preferably for producing and processing phosgene, said unit being configured for at least one production mode and at least one maintenance mode and comprising a structure which defines a confined space in a production mode, wherein
(i) the confined space contains at least one apparatus for producing phosgene, or for processing phosgene, or for producing and processing phosgene;
(ii) the structure comprises at least one openable and lockable transfer means for temporary removal, in a maintenance mode, of at least part of at least one apparatus according to (i) from the structure through at least one of said transfer means in opened state.

Depending on its size and the number of apparatuses contained in it in the production mode, the structure preferably comprises from 1 to 1000, preferably from 1 to 500, more preferably from 1 to 50 openable and lockable transfer means.

Not in all maintenance cases it will be the most time-saving method to move the to be maintained apparatus, or a part of it, out of the structure through an openable or lockable transfer means according to (ii). So, it can be preferred that
(iii) the structure further comprises at least one openable and lockable access means for temporary access, in a maintenance mode, of at least one of the apparatuses according to (i) from outside the structure.

Usually, less openable and lockable access means according to (iii) than openable and lockable transfer means according to (ii) are needed, because generally a human being can move more flexibly than an apparatus or part of an apparatus according to (i). So, it is preferred that the structure comprises from 1 to 100, preferably from 1 to 50, more preferably from 1 to 20 openable and lockable access means.

Sometimes, a structure having an openable and lockable access means according to (iii) will comprise an upper part of said structure and a lower part of said structure, wherein in the production mode said upper part is located on said lower part and the at least one apparatus according to (i) is located on said lower part. In this case, the upper part can constitute the openable and lockable access means according to (iii), for example because it is movable, especially liftable as a whole. The upper part or the lower part comprises the openable and lockable transfer means and optionally one or more further openable and lockable access means according to (iii). This gives even more flexibility in setting up the unit in a maintenance mode, such that depending on the maintenance work necessary, the most time-saving setup can be chosen.

The invention works on large scales as well as on small scales, so the confined space according to (i) typically contains from 1 to 100, preferably from 1 to 50, more preferably from 1 to 20 apparatuses according to (i).

In most cases, the structure comprises a housing, wherein
(iv) at least one opening is provided in said housing and at least one closing element for said opening is provided, said opening and said at least one closing element together forming the openable and lockable transfer means according to (ii).

The housing can consist of any suitable material, especially of concrete or metal (especially steel or aluminium).

The opening according to (iv) must be large enough that the apparatus according to (i) or a part of this apparatus fits through this opening. Preferably the opening of an openable and lockable transfer means has a cross-section in the range of from 1 to 50 m², more preferably in the range of from 2 to 40 m², more preferably in the range of from 5 to 30 m², more preferably in the range of from 10 to 25 m².

Usually, the at least one closing element according to (iv) comprises, preferably is, a pivoting door, a sliding door, or a panel, wherein said panel is designed to be at least partially, preferably completely, removable from the housing. The closing element according to (iv) can consist of any suitable material, for example aluminium or plastic, especially fibre reinforced plastic. In some applications also heavier materials like concrete or steel are possible. Especially in the case that the opening of an openable and lockable transfer means has a cross section of at least 10 m², in particular more than 10 m², it can be useful to use more than one panel for closing this opening.

The opening according to (iv) can be arranged at any location of the housing, usually in a sidewall or in a roof/top wall of the housing. Since the housing is often in shape of a cuboid or in a shape being comprised of cuboids, in most cases the at least one opening according to (iv) is located in an essentially horizontally extending part of the housing or in an essentially vertically extending part of the housing.

In order to fully use the advantages of the invention, it will often be preferred that more than one opening according to (iv) and thus more than one openable and lockable transfer means according to (ii) are provided. In order to ease the movement of the apparatus according to (i) towards the opening according to (iv), it can be preferred that at least one opening according to (iv) is located in an essentially horizontally extending part of the housing and at least one opening according to (iv) is located in an essentially vertically extending part of the housing.

In order to minimize the distances, the apparatuses according to (i) need to pass, it can be preferred to minimize the distances between two adjacent openings, meaning that at least part of the housing is in form of a skeleton to which a plurality of removable panels are removably attached. The removable panels form closing elements according to (iv).

As has already been mentioned, it can be preferred that the structure comprise at least one openable and lockable access means according to (iii) in addition to the openable and lockable transfer means according to (ii). In case that the structure comprises a housing, this means that
(v) at least one opening other than the at least one opening according to (iv) is provided in said housing and at least one closing element other than the at least one closing element according to (iv) for said opening is provided, said opening and said at least one closing element together forming the openable and lockable access means according to (iii).

Typically, the at least one opening according to (v) is smaller than the at least one opening according to (iv), or in other words: Typically the opening according to (v) has a smaller cross-section than the opening according to (iv). Preferably the opening according to (v) has a cross-section of at least 1 m². Often, it will be useful to provide larger openings, especially openings with a cross-section in the range of from 2 to 10 m², preferably in the range of from 3 to 8 m², more preferably in the range of from 4 to 6 m², more preferably in the range of from 4.5 to 5.5 m² such as about 5 m².

As the closing element according to (iv), the at least one closing element according to (v) usually comprises, preferably is, a pivoting door, a sliding door, or a panel, wherein said panel is designed to be at least partially, preferably completely, removable from the housing. It can consist of any suitable material, for example aluminium or plastic, especially fibre reinforced plastic, concrete or steel.

Like the opening according to (iv), the opening according to (v) can be arranged at any location of the housing, usually in a sidewall or in a roof/top wall of the housing. Since the housing is often in shape of a cuboid or in a shape being comprised of cuboids, in most cases the at least one opening according to (v) is located in an essentially horizontally extending part of the housing or in an essentially vertically extending part of the housing.

In order to fully use the advantages of the invention, it will often be preferred that more than one opening according to (v) and thus more than one openable and lockable access means according to (iii) are provided. In order to ease the movement of the maintenance worker from the opening according to (v) towards the apparatus according to (i) to be maintained, it can be preferred that at least one opening according to (v) is located in an essentially horizontally extending part of the housing and at least one opening according to (v) is located in an essentially vertically extending part of the housing.

As has been mentioned, the production and/or the processing of phosgene, preferably the production and processing of phosgene, usually take place in the same confined space and thus the unit most often comprises
(i.a) at least one apparatus for producing phosgene, and
(i.b) at least one apparatus for processing phosgene.

In this case it can be preferred that at least in a production mode the confined space according to (i) is sub-divided into
(i.i) at least one sub-space which contains at least one apparatus for producing phosgene according to (i.a);
(i.ii) at least one sub-space, other than the at least one sub-space according to (i.i), which contains at least one apparatus for processing phosgene according to (i.b).

This makes it possible to evacuate only one sub-space and/or the apparatus or apparatuses being contained in this sub-space from phosgene whereas the apparatus/apparatuses being contained in the other sub-space do not need to be emptied from phosgene. This reduces the amount of phosgene that needs to be removed from the unit in the case of a leakage as well as in the case of maintenance work.

Commonly, the unit comprises a phosgene line connecting an apparatus for producing phosgene according to (i.a) and an apparatus for processing phosgene according to (i.b) so that the apparatuses are in fluid communication with each other.

In order to prevent that phosgene from a leakage in the phosgene line reaches the environment, it is preferred that this phosgene line is located completely inside the confined space.

In order to create the possibility to disjoin the phosgene flow between the apparatus for producing phosgene and the apparatus for processing phosgene, it is preferred that the phosgene line comprises at least one closing valve, wherein it is even more preferred that the phosgene line comprises a first closing valve for an apparatus for producing phosgene according to (i.a) and a second closing valve, other than the first closing valve, for an apparatus for processing phosgene according to (i.b).

Additional benefits can be achieved if the phosgene line comprises at least one branch point thus forming a phosgene net to which at least two apparatuses for producing phosgene according to (i.a) and at least one apparatus for processing phosgene according to (i.b), or at least one apparatus for producing phosgene according to (i.a) and at least two apparatuses for processing phosgene according to (i.b) are connected, especially if all apparatuses for producing phosgene according to (i.a), comprised in the unit, and all apparatuses for processing phosgene according to (i.b), comprised in the unit, are connected to the phosgene net. With such a phosgene net it is in many cases possible to continue with the production—possibly with reduced capacity—while at least one apparatus is out of use and possibly maintained, especially if the confined space comprises at least two sub-spaces according to (i.i) and/or at least two sub-spaces according to (i.ii).

In order to make full use of the possibilities of a phosgene-net, it is preferred that it comprises a closing valve for each sub-space according to (i.i) and a closing valve for each sub-space according to (i.ii).

It can be preferred that at least one of the sub-spaces according to (i.i) or (i.ii) contains a phosgene buffer apparatus. This can help to continue with the production, even if an apparatus for producing phosgene according to (i.a) is not working, for example because of maintenance work.

Of course, the concept of dividing the confined space into sub-spaces is not limited to a unit comprising only two sub-spaces according to (i.i), it can comprise at least two sub-spaces according to (i.i), preferably from two to six sub-spaces according to (i.i), more preferably from two to four sub-spaces according to (i.i).

In the same way, the concept is not limited to a unit comprising only two sub-spaces according to (i.ii), it can comprise at least two sub-spaces according to (i.ii), preferably from two to six sub-spaces according to (i.ii), more preferably from two to four sub-spaces according to (i.ii).

Generally, the unit comprises a flushing device for flushing phosgene out of at least one of the apparatuses according to (i.a) or (i.b), which is preferably designed to additionally flush phosgene out of at least a part of the phosgene line, or—if present—out of at least part of the phosgene net.

Since it is one of the advantages of a unit having at least two sub-spaces that the unit can partially be emptied from phosgene, the flushing device preferably comprises a first flushing sub-device for an apparatus for producing phosgene according to (i.a) and a second flushing sub-device, other than the first flushing sub-device, for an apparatus for processing phosgene according to (i.b), especially a sub-device for each sub-space according to (i.i) and (i.ii).

Generally, the unit comprises an exhaust device with a suction end, said suction end being located inside the confined space according to (i). Such an exhaust device is often used in order to create a slight under-pressure inside the confined space and to free the confined space from phosgene in case of a leakage.

Since it will often be sufficient to evacuate only one sub-space from phosgene, it is preferred that the exhaust device comprises a first suction end inside a sub-space according to (i.i) and a second suction end, other than the first suction end, inside a sub-space according to (i.ii). In this case, the exhaust device is designed to exhaust a sub-space according to (i.i) and a sub-space according to (i.ii) independently from one another.

The advantages of the inventive unit can be fully used if the exhaust device comprises a suction end in each sub-space according to (i.i) and (i.ii).

Generally, the unit comprises a carbon monoxide (CO) supply line and a chlorine (Cl₂) supply line for supply of the apparatus for producing phosgene according to (i.a) with CO and Cl₂.

Since the reaction of CO and Cl₂ to phosgene is exothermic, the unit usually comprises a cooling liquid supply line and a cooling liquid return line for cooling the apparatus for producing phosgene according to (i.a) with the cooling liquid.

Second Type of Inventive Unit

Often, the at least one apparatus according to (i) is located close to the inner side of the structure, when the unit is in its production mode. Especially in these cases, it might not be necessary to move the apparatus according to (i) or a part of it, out of the structure, but to move away a part of the structure away from the apparatus according to (i). So, in a second inventive concept, a part of the structure is moving when the unit evolves from a production mode to a maintenance mode. As in the first inventive concept, the benefit of a time-saving maintenance work results from a relative movability of the apparatus to be maintained and at least a part of the structure.

Therefore, the present invention also relates to a unit for producing and/or processing phosgene, preferably for producing and processing phosgene, said unit being configured for at least one production mode and at least one maintenance mode and comprising a structure which defines a confined space in a production mode, wherein
(i) the confined space contains at least one apparatus for producing phosgene, or for processing phosgene, or for producing and processing phosgene;
(iii) the structure comprises an openable and lockable access means for temporary access, in a maintenance mode, of the at least one apparatus according to (i) from outside the structure;

wherein said openable and lockable access means according to (iii) is an upper part of said structure and said structure further comprises a lower part on which said upper part is movably or removably mounted in a production mode; and wherein the at least one apparatus according to (i) is located on said lower part.

As has been mentioned, the production and/or the processing of phosgene, preferably the production and processing of phosgene, usually take place in the same confined space and thus the unit most often comprises
(i.a) at least one apparatus for producing phosgene, and
(i.b) at least one apparatus for processing phosgene,

as in the unit according to the first type.

Commonly, also the unit according to the second type comprises a phosgene line connecting an apparatus for producing phosgene according to (i.a) and an apparatus for processing phosgene according to (i.b) so that the apparatuses are in fluid communication with each other.

Generally, also the unit according to the second type comprises a flushing device for flushing phosgene out of at least one of the apparatuses according to (i.a) or (i.b), which is preferably designed to additionally flush phosgene out of at least a part of the phosgene line, or, if present, out of at least part of the phosgene net.

Generally, also the unit according to the second type comprises an exhaust device with a suction end, said suction end being located inside the confined space according to (i). Such an exhaust device is often used in order to create a slight under-pressure inside the confined space and to free the confined space from phosgene in case of a leakage.

Generally, also the unit according to the second type comprises a carbon monoxide (CO) supply line and a chlorine (Cl₂) supply line for supply of the apparatus for producing phosgene according to (i.a) with CO and Cl₂.

Like in the unit according to the first type, the unit usually comprises a cooling liquid supply line and a cooling liquid return line for cooling the apparatus for producing phosgene according to (i.a) with the cooling liquid.

According to the present invention, the unit for producing and/or processing phosgene, preferably for producing and processing phosgene, particularly comprises according to (i) at least one apparatus for producing phosgene, or for processing phosgene, or for producing and processing phosgene, contained in the confined space. Further, said unit is particularly configured for at least one maintenance mode and at least one production mode. In the context of the present invention relating to a first type of inventive unit, in particular in accordance with embodiments 1 to 38 as disclosed herein, and a second type of inventive unit, in particular in accordance with embodiments 39 to 46 disclosed herein, an apparatus for producing phosgene, or for processing phosgene, or for producing and processing phosgene, can be in production mode or in maintenance mode, wherein during the production mode production of phosgene, or processing of phosgene, or production and processing of phosgene, is in progress, and wherein during maintenance mode neither production of phosgene nor processing of phosgene is in progress. Thus, it is preferred in the context of the present invention, that each apparatus for producing phosgene, or for processing phosgene, or for producing and processing phosgene, is in production mode or in maintenance mode, wherein during the production mode production of phosgene, or processing of phosgene, or production and processing of phosgene, is in progress, and wherein during maintenance mode neither production of phosgene nor processing of phosgene is in progress.

Usually, the unit according to the invention will be comprised in a production plant, preferably in a production plant for producing an isocyanate, more preferably in a production plant for producing a diisocyanate, more preferably in a production plant for producing a toluene diisocyanate, more preferably in a production plant for producing one or more of toluene-2,4-diisocyanate and toluene-2,6-diisocyanate.

The present invention is further illustrated by the following set of embodiments and combinations of embodiments resulting from the dependencies and back-references as indicated. In particular, it is noted that in each instance where a range of embodiments is mentioned, for example in the context of a term such as “The unit of any one of embodiments (1) to (4)”, every embodiment in this range is meant to be explicitly disclosed for the skilled person, i.e. the wording of this term is to be understood by the skilled person as being synonymous to “The unit of any one of embodiments (1), (2), (3), and (4)”. Further, it is explicitly noted that the following set of embodiments represents a suitably structured part of the general description directed to preferred aspects of the present invention, and, thus, suitably supports, but does not represent the claims of the present invention.
1. A unit for producing and/or processing phosgene, preferably for producing and processing phosgene, said unit being configured for at least one production mode and at least one maintenance mode and comprising a structure which defines a confined space in a production mode, wherein
   (i) the confined space contains at least one apparatus for producing phosgene, or for processing phosgene, or for producing and processing phosgene;
   (ii) the structure comprises at least one openable and lockable transfer means for temporary removal, in a maintenance mode, of at least part of at least one apparatus according to (i) from the structure through at least one of said transfer means in opened state.
2. The unit of embodiment 1, wherein the structure comprises from 1 to 1000, preferably from 1 to 500, more preferably from 1 to 50 openable and lockable transfer means.
3. The unit of embodiment 1 or 2, wherein
   (iii) the structure further comprises at least one openable and lockable access means for temporary access, in a maintenance mode, of at least one of the apparatuses according to (i) from outside the structure.
4. The unit of embodiment 3, wherein the structure comprises from 1 to 100, preferably from 1 to 50, more preferably from 1 to 20 openable and lockable access means.
5. The unit of embodiment 3 or 4, wherein an openable and lockable access means according to (iii) is an upper part of said structure, said structure comprising a lower part and said upper part being located, in a production mode, on said lower part, the at least one apparatus according to (i) being located on said lower part, said upper part or said lower part comprising the openable and lockable transfer means and optionally one or more further openable and lockable access means according to (iii).
6. The unit of any one of embodiments 1 to 5, wherein the confined space according to (i) contains from 1 to 100, preferably from 1 to 50, more preferably from 1 to 20 apparatuses according to (i).
7. The unit of any one of embodiments 1 to 6, wherein the structure comprises a housing, wherein
   (iv) at least one opening is provided in said housing and at least one closing element for said opening is provided, said opening and said at least one closing element together forming the openable and lockable transfer means according to (ii).
8. The unit of embodiment 7, wherein the at least one closing element according to (iv) comprises, preferably is, a pivoting door, a sliding door, or a panel, wherein said panel is designed to be at least partially, preferably completely, removable from the housing.
9. The unit of embodiment 7 or 8, wherein at least one opening according to (iv) is located in an essentially horizontally extending part of the housing.
10. The unit of embodiment 7 or 8, wherein at least one opening according to (iv) is located in an essentially vertically extending part of the housing.
11. The unit of embodiment 7 or 8, wherein at least one opening according to (iv) is located in an essentially horizontally extending part of the housing and at least one opening according to (iv) is located in an essentially vertically extending part of the housing.
12. The unit of any one of embodiments 7 to 11, wherein at least part of the housing is in form of a skeleton to which a plurality of removable panels are removably attached, said removable panels forming closing elements according to (iv).
13. The unit of any one of embodiments 7 to 12, insofar as directly or indirectly referring to embodiment 3 or 4, wherein
   (v) at least one opening other than the at least one opening according to (iv) is provided in said housing and at least one closing element other than the at least one closing element according to (iv) for said opening is provided, said opening and said at least one closing element together forming the openable and lockable access means according to (iii).
14. The unit of embodiment 13, wherein the at least one closing element according to (v) comprises, preferably is, a pivoting door, a sliding door, or a panel, wherein said panel is designed to be at least partially, preferably completely, removable from the housing.
15. The unit of embodiment 13 or 14, wherein the opening according to (v) is located in an essentially horizontally extending part of the housing.
16. The unit of embodiment 13 or 14, wherein the opening according to (v) is located in an essentially vertically extending part of the housing.
17. The unit of embodiment 13 or 14, wherein at least one opening according to (v) is located in an essentially horizontally extending part of the housing and at least one opening according to (v) is located in an essentially vertically extending part of the housing.
18. The unit of any one of embodiments 1 to 17, wherein the confined space according to (i) contains (i.a) at least one apparatus for producing phosgene, and (i.b) at least one apparatus for processing phosgene.
19. The unit of embodiment 18, wherein at least in a production mode the confined space according to (i) is sub-divided into
   (i.i) at least one sub-space which contains at least one apparatus for producing phosgene according to (i.a);
   (i.ii) at least one sub-space, other than the at least one sub-space according to (i.i), which contains at least one apparatus for processing phosgene according to (i.b).
20. The unit of embodiment 18 or 19, comprising a phosgene line connecting an apparatus for producing phosgene according to (i.a) and an apparatus for processing phosgene according to (i.b) so that the apparatuses are in fluid communication with each other.
21. The unit of embodiment 20, wherein the phosgene line is located completely inside the confined space.
22. The unit of embodiment 20 or 21, wherein the phosgene line comprises at least one closing valve.
23. The unit of embodiment 22, wherein the phosgene line comprises a first closing valve for an apparatus for producing phosgene according to (i.a) and a second closing valve, other than the first closing valve, for an apparatus for processing phosgene according to (i.b).
24. The unit of any one of embodiments 20 to 23, wherein the phosgene line comprises at least one branch point thus forming a phosgene net to which at least two apparatuses for producing phosgene according to (i.a) and at least one apparatus for processing phosgene according to (i.b), or at least one apparatus for producing phosgene according to (i.a) and at least two apparatuses for processing phosgene according to (i.b) are connected.
25. The unit of embodiment 24, wherein all apparatuses for producing phosgene according to (i.a), comprised in the unit, and all apparatuses for processing phosgene according to (i.b), comprised in the unit, are connected to the phosgene net.
26. The unit of embodiment 24 or 25, wherein the phosgene net comprises a closing valve for each sub-space according to (i.i) and a closing valve for each sub-space according to (i.ii).
27. The unit of any one of embodiments 19 to 26, wherein at least one of the sub-spaces according to (i.i) or (i.ii) contains a phosgene buffer apparatus.
28. The unit of any one of embodiments 19 to 27, comprising at least two sub-spaces according to (i.i), preferably from two to six sub-spaces according to (i.i), more preferably from two to four sub-spaces according to (i.i).
29. The unit of any one of embodiments 19 to 28, comprising at least two sub-spaces according to (i.ii), preferably from two to six sub-spaces according to (i.ii), more preferably from two to four sub-spaces according to (i.ii).
30. The unit of any one of embodiments 1 to 29, comprising a flushing device for flushing phosgene out of at least one of the apparatuses according to (i).
31. The unit of embodiment 30, wherein said flushing device is designed to additionally flush phosgene out of at least part of the phosgene line, as defined in any one of embodiments to 23, or out of at least part of the phosgene net, as defined in any one of embodiments 24 to 26.
32. The unit of embodiment 31, as far as directly or indirectly referring to embodiment 18, wherein said flushing device comprises a first flushing sub-device for an apparatus for producing phosgene according to (i.a) and a second flushing sub-device, other than the first flushing sub-device, for an apparatus for processing phosgene according to (i.b).
33. The unit of any one of embodiments 19 to 26 and to any one of the claims 30 to 32, wherein the flushing device comprises a sub-device for each sub-space according to (i.i) and (i.ii).
34. The unit of any one of embodiments 1 to 33, comprising an exhaust device with a suction end, said suction end being located inside the confined space according to (i).
35. The unit of embodiment 34 as long as directly or indirectly referring to embodiment 19, wherein the exhaust device is designed to exhaust a sub-space according to (i.i) and a subs-pace according to (i.ii) independently from one another.
36. The unit of embodiment 35, wherein the exhaust device comprises a suction end in each sub-space according to (i.i) and (i.ii).
37. The unit of any one of embodiments 1 to 36, in particular insofar as directly or indirectly referring to embodiment 18, comprising a carbon monoxide (CO) supply line and a chlorine (Cl₂) supply line for supply of the apparatus for producing phosgene according to (i.a) with CO and Cl₂.
38. The unit of any one of embodiments 1 to 37, in particular insofar as directly or indirectly referring to embodiment 18, comprising a cooling liquid supply line and a cooling liquid return line for cooling the apparatus for producing phosgene according to (i.a) with the cooling liquid.
39. A unit for producing and/or processing phosgene, preferably for producing and processing of phosgene, said unit being configured for at least one production mode and at least one maintenance mode and comprising a structure which defines a confined space in a production mode, wherein
   (i) the confined space contains at least one apparatus for producing phosgene, or for processing phosgene, or for producing and processing phosgene;
   (iii) the structure comprises an openable and lockable access means for temporary access, in a maintenance mode, of the at least one apparatus according to (i) from outside the structure;
   wherein said openable and lockable access means according to (iii) is an upper part of said structure and said structure further comprises a lower part on which said upper part is movably or removably mounted in a production mode; and wherein the at least one apparatus according to (i) is located on said lower part.
40. The unit of embodiment 39, wherein the confined space according to (i) contains
   (i.a) at least one apparatus for producing phosgene, and
   (i.b) at least one apparatus for processing phosgene.
41. The unit of embodiment 40, comprising a phosgene line connecting an apparatus for producing phosgene according to (i.a) and an apparatus for processing phosgene according to (i.b) so that the apparatuses are in fluid communication with each other.
42. The unit of any one of embodiments 39 to 41, comprising a flushing device for flushing phosgene out of at least one of the apparatuses according to (i).
43. The unit of embodiment 42, wherein said flushing device is designed to additionally flush phosgene out of at least part of the phosgene line, as defined in embodiment 41.
44. The unit of any one of embodiments 39 to 43, comprising an exhaust device with a suction end, said suction end being located inside the confined space according to (i).
45. The unit of any one of embodiments 39 to 44 as long as directly or indirectly referring to embodiment 40, comprising a carbon monoxide (CO) supply line and a chlorine (Cl₂) supply line for supply of the apparatus for producing phosgene according to (i.a) with CO and Cl₂.
46. The unit of any one of embodiments 39 to 45 as long as directly or indirectly referring to embodiment 40, comprising a cooling liquid supply line and a cooling liquid return line for cooling the apparatus for producing phosgene according to (i.a) with the cooling liquid.
47. The unit of any one of embodiments 1 to 46, wherein each apparatus for producing phosgene, or for processing phosgene, or for producing and processing phosgene, is in production mode or in maintenance mode, wherein during the production mode production of phosgene, or processing of phosgene, or production and processing of phosgene, is in progress, and wherein during maintenance mode neither production of phosgene nor processing of phosgene is in progress.
48. The unit of any one of embodiments 1 to 47, being comprised in a production plant, preferably in a production plant for producing an isocyanate, more preferably in a production plant for producing toluene diisocyanate, more preferably in a production plant for producing toluene-2,4-diisocyanate.
49. A production plant, preferably for producing an isocyanate, more preferably a production plant for producing a diisocyanate, more preferably a production plant for producing a toluene diisocyanate, more preferably a production plant for producing one or more of toluene-2,4-diisocyanate and toluene-2,6-diisocyanate, said production plant comprising a unit according to any one of embodiments 1 to 47.
50. Use of a unit according to any one of embodiments 1 to 49 in a production plant, preferably in a production plant for producing an isocyanate, more preferably in a production plant for producing a diisocyanate, more preferably in a production plant for producing a toluene diisocyanate, more preferably in a production plant for producing one or more of toluene-2,4-diisocyanate and toluene-2,6-diisocyanate.

The invention will now be further described by means of example embodiments in view of the figures. The figures show:

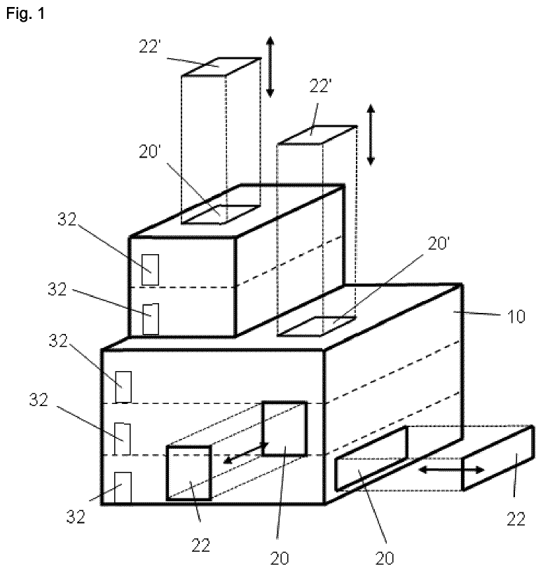

FIG. 1 an example embodiment of a first type of a unit according to the invention in a schematic perspective representation.

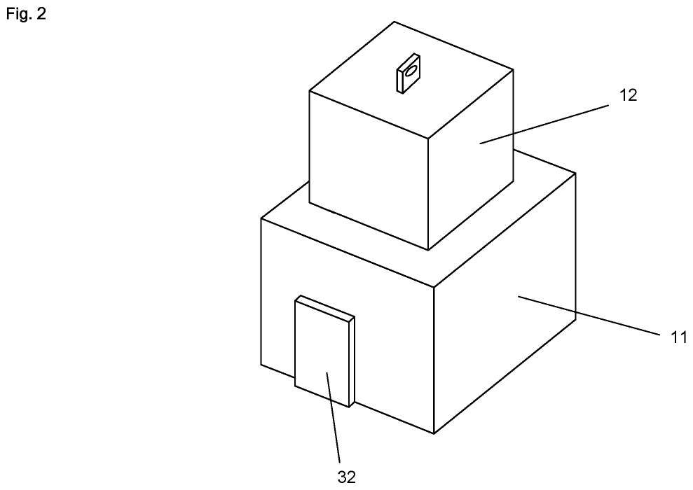

FIG. 2 an example embodiment of a second type of a unit according to the invention in a schematic perspective representation.

FIG. 1 shows schematically an example of a structure of the inventive unit according to the first type. This structure comprises a housing 10. The housing can have an own floor. In this case, the structure is comprised of the housing 10. If the housing does not have an own floor, usually the base on which the housing stands and the housing 10 together constitute the structure. As is typical for such a housing, it is geometrically a cuboid, or consists of cuboids; in the example embodiment shown, two cuboids. So, the outer walls of the housing extend either horizontally or vertically. In a production mode, the structure defines a confined space in which a plurality of apparatuses for producing or processing phosgene is located. In the embodiment shown, the housing has five levels.

The housing has a plurality of openings and further comprises panels and doors for closing those openings in a production mode of the unit. In the embodiment shown each panel/door is assigned to one opening. There are two types of openings, namely openings 20, 20′ of transfer means and openings of access means. In the production mode, the openings of the access means are closed by doors 32 and the openings 20, 20′ of the transfer means are closed by panels 22, 22′. One panel and one opening constitute a transfer means, one door and one opening constitute an access means. The openings of the access means have a typical “door size” of about 1 m in width and 2 m in height. The openings of the transfer means are substantially larger.

In the embodiment shown, each level of the housing 10 has one access means, and the first, second third, and fifth level have a transfer means. Two openings 20 of the transfer means are each located in a side wall and thus extending in a vertical plane, and two are each located in a top wall and thus extending in a horizontal plane.

As has been mentioned, in a production mode, all doors 32 and panels 22 are closed. In a maintenance mode, the doors 32 can be opened to give maintenance workers access to the inside of the housing. Further, the panels 22 can be removed so that an apparatus or a part of an apparatus can be moved through the respective opening 20, 20′ such that it can be maintained outside the housing.

FIG. 2 shows schematically an example of a structure of the inventive unit according to the second type. The structure also comprises or is comprised of a housing. This housing has a lower part 11 and an upper part 12. The lower part has an access means as described above. The door 32 of which can be seen. The lower part 32 could additionally have a transfer means, but such a transfer means is not shown in FIG. 2. The lower part 11 of the housing houses at least one apparatus for producing and/or for processing phosgene and the upper part 12 of the housing houses another apparatus for producing and/or processing phosgene. This other apparatus stands on the top wall of the lower part 11. In a maintenance mode, the upper part 12 can be lifted from lower part 11, such that the apparatus housed by the upper part 12 can be accessed. Thus, the upper part 12 itself forms an openable and lockable access means of the unit.

### LIST OF REFERENCE NUMBERS IN THE FIGURES

10 housing
11 lower part of housing
12 upper part of housing
20, 20′ opening of transfer means
22, 22′ panel of transfer means
32 door of access means

1.-15. (canceled)

16. A unit for producing and/or processing phosgene, said unit being configured for at least one production mode and at least one maintenance mode and comprising a structure which defines a confined space in a production mode, wherein
(i) the confined space contains at least one apparatus for producing phosgene, or for processing phosgene, or for producing and processing phosgene;
(ii) the structure comprises at least one openable and lockable transfer means for temporary removal, in a maintenance mode, of at least part of at least one apparatus according to (i) from the structure through at least one of said transfer means in opened state.

17. The unit of claim 16, wherein the structure comprises from 1 to 1000 openable and lockable transfer means.

18. The unit of claim 16, wherein
(iii) the structure further comprises at least one openable and lockable access means for temporary access, in a maintenance mode, of at least one of the apparatuses according to (i) from outside the structure.

19. The unit of claim 18, wherein the structure comprises from 1 to 100 openable and lockable access means.

20. The unit of claim 18, wherein an openable and lockable access means according to (iii) is an upper part of said structure, said structure comprising a lower part and said upper part being located, in a production mode, on said lower part, the at least one apparatus according to (i) being located on said lower part, said upper part comprising the openable and lockable transfer means and optionally one or more further openable and lockable access means according to (iii).

21. The unit of claim 16, wherein the confined space according to (i) contains from 1 to 100 apparatuses according to (i).

22. The unit of claim 16, wherein the structure comprises a housing, wherein
(iv) at least one opening is provided in said housing and at least one closing element for said opening is provided, said opening and said at least one closing element together forming the openable and lockable transfer means according to (ii).

23. The unit of claim 22, wherein at least part of the housing is in form of a skeleton to which a plurality of removable panels are removably attached, said removable panels forming closing elements according to (iv).

24. The unit of claim 22, insofar as directly or indirectly referring to embodiment 3 or 4, wherein
(v) at least one opening other than the at least one opening according to (iv) is provided in said housing and at least one closing element other than the at least one closing element according to (iv) for said opening is provided, said opening and said at least one closing element together forming the openable and lockable access means according to (iii).

25. The unit of claim 16, wherein the confined space according to (i) contains
(i.a) at least one apparatus for producing phosgene, and
(i.b) at least one apparatus for processing phosgene.

26. The unit of claim 25, wherein at least in a production mode the confined space according to (i) is sub-divided into
(i.i) at least one sub-space which contains at least one apparatus for producing phosgene according to (i.a);
(i.ii) at least one sub-space, other than the at least one sub-space according to (i.i), which contains at least one apparatus for processing phosgene according to (i.b).

27. A unit for producing and/or processing phosgene, said unit being configured for at least one production mode and at least one maintenance mode and comprising a structure which defines a confined space in a production mode, wherein
(i) the confined space contains at least one apparatus for producing phosgene, or for processing phosgene, or for producing and processing phosgene;
(iii) the structure comprises an openable and lockable access means for temporary access, in a maintenance mode, of the at least one apparatus according to (i) from outside the structure;
wherein said openable and lockable access means according to (iii) is an upper part of said structure and said structure further comprises a lower part on which said upper part is movably or removably mounted in a production mode; and
wherein the at least one apparatus according to (i) is located on said lower part.

28. The unit of claim 16, being comprised in a production plant.

29. A production plant comprising a unit according to claim 16.

30. Use of a unit according to claim 16 in a production plant.
